(19) United States
(12) Patent Application Publication
(10) Pub. No.: US 2014/0143250 A1
(43) Pub. Date: May 22, 2014

(54) Centralized Tracking of User Interest Information from Distributed Information Sources

(71) Applicant: XEN, Inc., (US)

(72) Inventors: Jonathan Brooks Martin, Los Angeles, CA (US); Andrew Charles Walraven, Los Angeles, CA (US); Alan Turner, Crooms Hill, London (UK); Patrick John Kearney, Los Angeles, CA (US); Larry Kenneth Davidson, Los Angeles, CA (US); Mark Alexander Christensen, Los Angeles, CA (US)

(73) Assignee: XEN, Inc., Los Angeles, CA (US)

(21) Appl. No.: 13/854,073

(22) Filed: Mar. 30, 2013

Related U.S. Application Data
(60) Provisional application No. 61/618,647, filed on Mar. 30, 2012.

(51) Int. Cl. G06F 17/30

(52) U.S. Cl. CPC G06F 17/30598
USPC 707/737

(57) ABSTRACT

User interest information, including both explicit and implicit interests, is aggregated from numerous distributed information sources and stored in a canonical format. This user interest information can in turn be accessed, edited and analyzed to provide a variety of useful applications for end users and entities that provide information sources.

### CROSS-REFERENCE TO RELATED APPLICATIONS

This application is a nonprovisional application of provisional patent application 61/618,647, filed Mar. 30, 2012.

### BACKGROUND

Most computer systems, such as websites, other information sources, and the like, make some attempt to capture information about the behavior of computer users that access the computer system.

For example, a website typically tracks login attempts, queries made, purchase histories, content viewing histories and the like. This information is often used by the website to select content to be displayed to the user, especially advertisements, promotions and other content that is related to revenue opportunities for the website owner.

A social networking website also typically has access to information about users, such who their friends are, pictures, likes and dislikes, and so on. Such information also can be used by a computer system to select content to be transmitted to the user, especially advertisements, promotions and other content that is related to revenue opportunities for the website owner.

The typical computer system, however, typically only has access to information provided to it by a user when that user is accessing the computer system. Thus, the information accessed on the computer system provides an incomplete description of the user's interests and behavior, because the computer system is isolated from information from other computer systems used by the user. Further, the information stored on the computer system is not controlled by the user; users therefore have a disincentive to provide full information access to the computer system that is tracking their behavior.

### SUMMARY

User interest information, including both explicit and implicit interests, is aggregated from numerous distributed information sources and stored in a canonical format. This user interest information can in turn be accessed, edited and analyzed to provide a variety of useful applications for end users and for entities that provide information sources.

To collect the user interest information, each information source that is participating in the system has an application programming interface installed within its computer system to interface with a repository. The repository aggregates user interest information for a user from multiple information sources into a canonical format that is consistent across users and across information sources.

The application programming interface allows each information source to connect with the repository. User interest information from the information source is associated with the user's identifying information for using the information source, such as a user name or other user identifier. The repository, through input from a user, associates the user with that user's user names for the various information sources used by that user. Thus, when the repository receives the user interest information and user identifier from an information source, the repository can associate it with a user of the repository.

In addition, the information source can request a user's interest graph using that user's user identifier for that information source. The information source does not need to have access to the user's account information with the repository.

In one implementation, the canonical format of the aggregated user interest information is in the form of an interest graph, which stores information about a user's explicit and implicit interests, activities and connections to other users. In one implementation of this interest graph, the explicit and implicit interests are represented by a first graph, a second graph represents relationships or social connections, and a third graph represents activities of the user or behaviors. The three graphs form a semantic triple that characterizes the interests of the user.

The set of possible interests can be very large (e.g., several million), with each interest having its own textual label. These interests can be hierarchically ordered as well. For purposes of visualization and the like, each interest can be associated with a color, and conceptually similar interests can have colors that are similar.

To collect user interest information into an interest graph, a variety of mechanisms can be employed. For example, a user's interactions with an information source can be tracked. A user's interactions with other users through an information source also can be tracked. These two general categories of information gathering develop implicit user interest information. In addition, users can explicitly communicate information about topics in which they are interested.

An example mechanism through which a user can explicitly communicate an interest is through a device called herein an “interest tag.” An interest tag represents an interest, and is associated with content and is displayed on a user's display adjacent that content. In one example implementation, an interest tag is placed immediately adjacent to an edge of the displayed content, such as at the beginning of text of an article, or beneath a video window. In one implementation, an interest tag can include a textual label of the interest, and optionally a band of color that is the color associated with that interest. In another implementation, input buttons also can be displayed with labels indicating “interested” (e.g., a check mark), or “not interested” (e.g., an “x”). If a user indicates interest by selecting the “interested” button, this interest is added to the user's interest graph or the user's interest graph is otherwise updated to reflect this interest. If a user indicates a lack of interest by selecting the “not interested” button, this interest can be removed from the user's interest graph (or the user's interest graph can be updated to show a lack of interest).

Given such an interest graph, a variety of applications can be provided. For example, content displayed on a web site can be selected based on the interest graph of a user accessing the web site. Advertisements also can be selected using the interest graph. Entities can be matched together by comparing interest graphs. Such a matching can include matching users with common interests. Matching entities also can include matching a company or brand with a user.

A graphical representation of a user's interest graph also can be provided. This graphical representation uses the colors associated with each interest and the hierarchy of interests to build a graphical tree of the user's interests. Such a graphical representation provides a compact visual way to convey a user's interests.

The repository that maintains the user interest information also can include an account manager that allows a user to login, manipulate interest graphs and maintain account information, particularly privacy settings.

### DESCRIPTION OF THE DRAWINGS

FIG. 1 is a data flow diagram of an example system for centralized tracking of user interest information from distributed information sources.

FIG. 2 is a data flow diagram of an example implementation of the interconnection between an information source and user interest manager.

FIG. 3 illustrates an example implementation of the user interest graph manager.

FIG. 4 illustrates an example process for a user to create a user interest graph using the system of FIG. 3.

FIG. 5 illustrates an example implementation of how a user interest graph can be used by an information source.

FIG. 6 illustrates an example implementation of how content is matched to a user's interest.

FIG. 7 illustrates an example implementation of interest landing pages.

FIG. 8 illustrates an example implementation of how content can be processed.

FIG. 9 is an illustration of an example data model for use in the user interest manager system.

FIG. 10 is an illustration of an example interest graph

FIG. 11 is an illustration of an example interest profile page.

### DETAILED DESCRIPTION

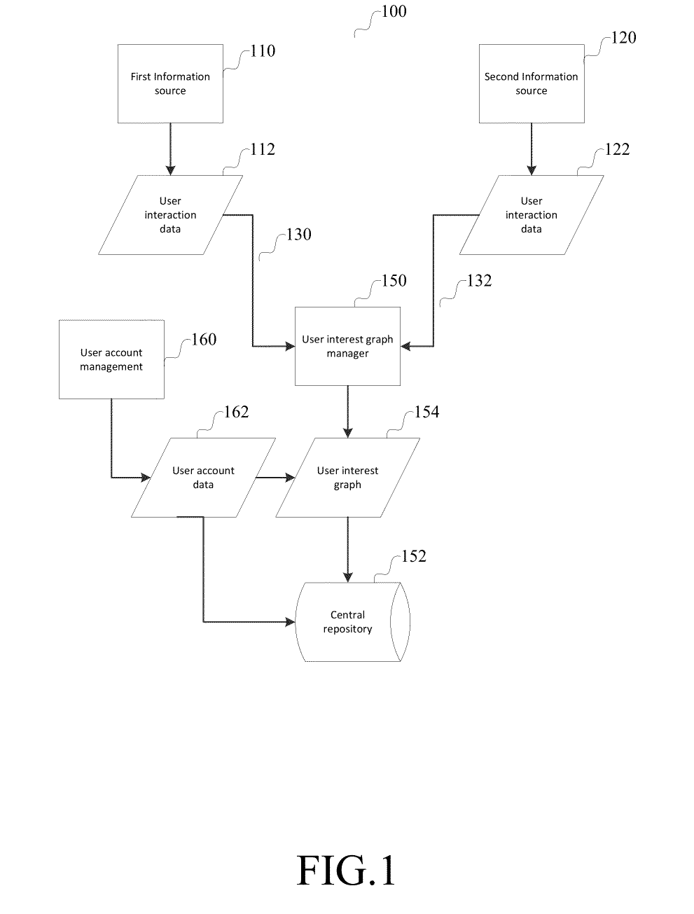

Referring to FIG. 1, a data flow diagram of an example computer system 100 for centralized tracking of user interest information from distributed information sources will now be described. Computer system 100 includes at least first and second information sources 110, 120, where the first and second information sources are different. An information source can be, for example, a web site accessible on the internet.

Users (not shown) interact with the information sources 110 and 120, typically through client computers (not shown) that access the information sources 110 and 120 over a computer network (not shown), such as the internet. In response to such user interaction, the information sources generate data 112, 122 describing the user interaction with the information source. This data generally includes an indication of content accessed by the user, one or more topics associated with the content, and an action by the user associated with the content. For example, a uniform resource locator (URL) of a page accessed on the web site, and information about that page, and the date, time and other information about the actions of the user with respect to that page can be stored.

A central user interest manager 150 connects with the information sources 110 and 120 over computer network(s) 130, 132. The user interest manager 150 receives the data 112, 122 describing users' interactions with the information sources into a memory (not shown). In particular, the user interest manager 150 receives first data 112 describing a first user's interaction with the first information source 110 and second data 122 describing the first user's interaction with the second information source 120. Even more information sources can be accessed by the first user, with such user interaction data tracked from those information sources. With multiple users, and additional information sources, the user interest manager receives, for example, from a third information source (not shown), third data describing a second user's interaction with the third information source into memory, and, from a fourth information source (not shown) different from the third information source, fourth data describing the second user's interaction with the fourth information source into memory. The third and fourth information sources may include or may be different from the first and second information sources 110, 120 and may be connected to the user interest manager 150 over one or more computer networks. A similar pattern of interaction applies with each additional user and additional information sources.

The user interest manager 150 processes the stored user interaction data for each user, and maintains a user interest graph 154 for the user based on the user interaction data for the user. In particular, the user interest manager 150 generates a first interest graph of the first user's interests from the first data and the second data 112, 122. The user interest manager 150 generates a second interest graph of the second user's interests from the third data and the fourth data. The interest graphs are maintained by updating them as additional user interaction data is received over time. Each user interest graph 154 is stored and maintained by the user interest manager 150 in a central repository 152.

The first and second information sources 110 and 120, and central user interest manager 150 can be implemented using a form of enterprise class server computer that is designed to be robust and secure and handle large amounts of computer network traffic and volume of transactions. One or more server computers are commonly used to support commercial web sites on the internet. The one or more server computers supporting the central user interest manager 150 are general purpose computer systems that are programmed to implement the functions described herein.

The user interest graph 154 has a canonical format, meaning the format is consistent across users. This interest graph stores information about a user's explicit and implicit interests, activities and connections to other users. An explicit interest is an interest that has been explicitly indicated by a user as an interest. An implicit interest is an interest that has been inferred from a user's behavior and/or connections with other entities and users. The interest graph can be constructed as a hierarchically ordered ontology of topics, wherein the user's interest in a topic is represented by a score associated with the topic. Example implementations of a user interest graph are described in more detail below. In one implementation, each user interest graph is based on the same hierarchically ordered ontology topics, with each user's interests being reflected in the scores associated with the topics. The user graph can have three parts: interest data, social data and behavior data, as described in more detail below. In one implementation of this interest graph, the explicit and implicit interests are represented by a first graph (the interest data), a second graph represents relationships or social connections (the social data), and a third graph represents activities of the user or behaviors (the behavior data). The three graphs form a semantic triple that characterizes the interests of the user. Yet additional graphs can be provided to track other facets, such as influence, expertise and the like.

The set of possible interests can be very large (e.g., several million), with each interest having its own textual label. These interests can be hierarchically ordered. For purposes of visualization and the like, each interest can be associated with a color and conceptually similar interests can have colors that are similar.

In one implementation, to associate each user with his or her user interaction data, each user has an account with the user interest manager and an account with the information sources. User account information for a user at the various information sources is associated with that user's account with the user interest manager. For example, a user, called “user_{—}1,” at the user interest manager may also have an account with a user name “username1” at a first social media website, an account with a user name “username1” at a second social media website, and an account with a user name “username1” at a third social media website. The user interest manager associates these user names with the user name “user_{—}1.”

To this end, the user interest manager 150 that maintains the user interest information also can have a related account manager 160. The account manager 160 that allows a user to login, manipulate interest graphs and maintain user account information 162. The user account information can include a variety of personal data to identify the user. In addition the account information can include the usernames used by the user on a variety of information sources. The user account information also can include privacy settings.

In such an implementation, when an information source provides user interaction data to the user interest manager, it provides the interaction data and data that associates the interaction data with a user, such as a user name or other identifier from that information source. Thus, when the user interest manager receives user interaction data tagged with a user name, for example, it matches the user name for the information source with its corresponding user name for the user interest manager to identify the user, and then updates that user's interest graph accordingly.

By connecting with the information sources in this matter, a user's user name or other identifying information at the user interest manager is not accessed by the information source. Further, the user interest manager can correlate data from different information sources for the same user only if that user informs the central repository of the user account information used on those different information sources.

A user interest graph can be created and maintained for, and a user can be, individuals as well as other entities, such as corporations, and other groups of people, so long as the user has an account with the user interest manager and has user account information for various information sources.

As will be described in more detail below, such a collection of user interest information enables a variety of operations to be performed in such a computer system. For example, an information source can request information about a user's interests and then target content, whether multimedia content for consumption or advertisements, to the user based on those interests. Users with similar interests can be identified by comparing their user interest graphs. Such matching could identify, for example, individuals with similar interests, entities that have interests similar to an individual's, and entities with similar interests. Also, variety of user interface features can be provided to assist a user in interacting with the computer system, such as tools for viewing and manipulating interest graphs.

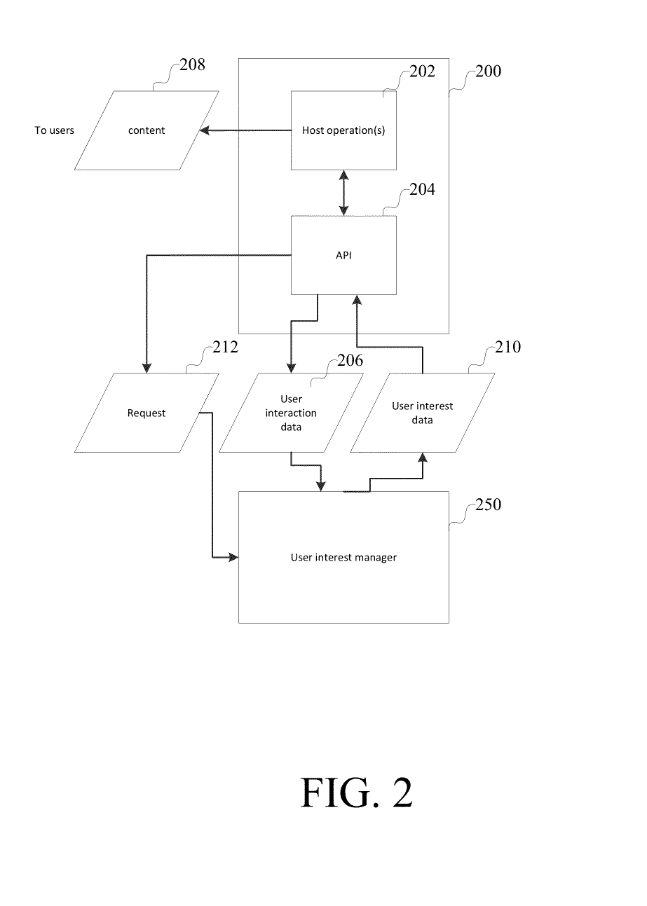

Referring now to FIG. 2, details of a specific implementation of the interconnection between an information source and user interest manager, such as in FIG. 1, will now be described. In this implementation, the connection between an information source and the user interest manager is provided by an application programming interface library designed to be installed at the information source and to communicate with the user interest manager. In particular, an information source 200 includes its own host operations 202 which access an application programming interface (API) library 204. The application programming interface can be implemented using RESTful calls to access and manipulate data about interests, users and content. The host operations 202 generally are those various operations performed by the information source while interacting with users, from which user interaction data 206 can be derived and which provide content 208 to users of the information source. The API library 204 can include commands that, when invoked by the host operations 202, cause user interaction data 206 to be transferred to the user interest manager 250. Also, the API library can include commands that, when invoked by the host operations 202, cause the host to send a request 212 for user interest data 210 to the user interest manager 250. In response, the user interest manager 250 can return the requested user interest data 210. The API library receives this information and passes it on to host operations 202. The API library can include a variety of commands that can be invoked by the host operations to access, send data to, and request data from, the user interest manager.

An example list of commands in the API and the operations they perform are the following.

For searching, some example API calls are:

GET /search/interests is used to perform a search on interests. It can have parameters such as the name of an interest to search for, and a facet on which to sort the results, and a kind of matching to be performed.

GET /search/interests/suggest is used to obtain suggested interests given a name of an interest.

GET /search/users is used to search for users, given some information identifying a user, such as a name and email address.

The entity issuing such search commands receives, in response, the results of performing the search on the database.

To manipulate interests, the following commands are provided.

“POST /interests” creates a new interest, given a category for the interest and other properties for the interest. “PUT /interests/:iid” modifies the properties of a specifically identified interest. “GET /interests/:iid” retrieve the properties of a specifically identified interest.

“GET /interests/trending” is used to obtain a list of trending interests. “GET /interests/recent” is used to obtain a list of recently changed interests.

A variety of commands can be used to obtain specific information about an interest. For example, “GET /interests/:iid/followers” returns a list of users following an interest. “GET /interests/:iid/stats” obtains affinity statistics for an interest. “GET /interests/:iid/collections” returns a list of collections an interest belongs to. “GET /interests/:iid/links” returns a list of most popular links to related web sites.

To access information about links for interest, the following commands are provided.

“GET /interests/links/:lid” obtains a single interest link. “GET /interests/:iid/links/new obtains a list of newest links to related web sites. “POST /interests/:iid/links” adds a new link to an interest. “PUT /interests/:iid/links/:lid” updates a link on an interest. “DELETE /interests/:iid/links/:lid” deletes a link on an interest.

In addition to commands for logging in and logging out a user, a variety of other commands related to a user can be provided. For example:

“GET /users/:uid” is used to obtain a specific user's information. “GET /users/:uid/stats” returns affinity statistics for the specified user. “PUT /users/:uid” allows specified properties to be updated in a specified user's information. “GET /users/:uid/:source/interests” looks up a user's interest on a source. “GET /users/:uid/interests/:iid” obtains properties of a specific interest for a specific user. “GET /users/:uid/interests” obtains the interests of a specified user. “POST /users/:uid/interests” is used to add an interest to a user. “PUT /users/:uid/interests” modifies a user's interests. Finally “DELETE /users/:uid/interests/:iid” removes a specific interest from a user. Finally to add a flag to a piece of content, the call “POST /flag” can be used.

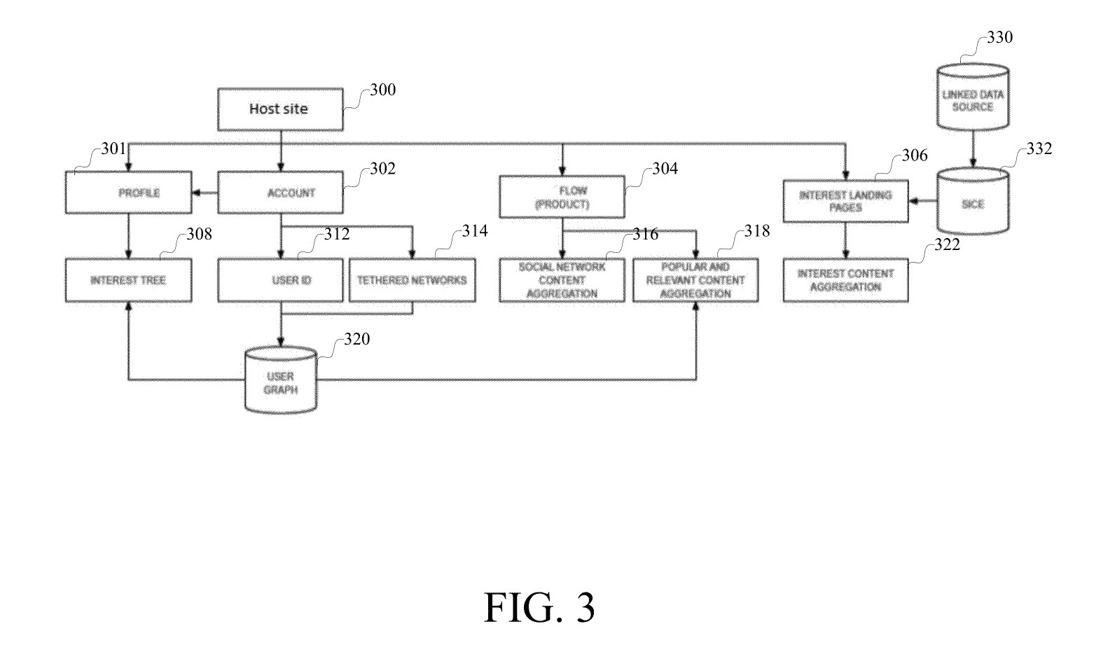

A specific implementation the user interest manager of FIG. 1 will now be described in more detail in connection with FIG. 3. The user interest manager is accessed through a computer network such as the internet, and thus has a main or home “page” 300. From this page 300, a user can access a profile module 301, an account module 302, a “flow” module 304 (to be described in more detail below), and interest landing pages 306. Such modules can be implemented as web pages.

Through the profile module 300, a user can log in to access a user profile, including but not limited to information about his or her interest graph 308. The user can be prompted, through a user interface, for personal information that is stored in a semi-structured format. Some of the profile is defined by fields having fixed names and field data formats, whereas other parts of the profile can be free form.

Through the account module 302, a user can log in to access and maintain information about the user. In particular, the user can maintain account information such as a user identifier 312, and tethered networks 314, i.e., the information sources that the user is connecting to and from which user interaction data will be gathered by the user interest manager. The user identifier and tethered networks are used to maintain the user interest graph 320, which provides an interest graph 308.

The “flow” module 304 is an example module that processes user interaction data to update the user graph 320. It has a submodule 316 for handling user interaction data from social networks and a submodule 318 for handling user interaction data related to other content, such as typical websites. To update a user graph, the activity data is stored in a user's behavior graph. A score is applied to each action, and the resulting score is stored in the interest and social graphs. Such scoring can be expanded to calculate influence and expertise, and other facets, on subjects, people and brands. In one implementation, the behavior graph tracks actions of the user. Each kind of action is associated with a value. The action can be related to a topic or an entity or both. The value for that action is added to previously determined values for actions that also occurred with respect to that topic or entity in the interest and social graphs, respectively. By tracking and storing each action, the table of actions and associated values can be modified, and the scoring for the interest and social graphs can be recalculated.

As users interact with the application, certain interaction types (viewing, sharing, rating, commenting, etc.) are logged, along with data about what the user interacted with (e.g., an interest topic, another user, a content item, etc.). Each interaction type can be assigned a score, based on the level of engagement it indicates. For example, sharing a particular interest topic or item generally indicates more engagement than simply viewing it, and thus has a higher score.

Actual scoring calculations may take place at the time of the interaction, or at later times. Scores can be additive and can be applied to the combination of a user and the item they have interacted with—interest topics, users or content items.

Items with low scores, indicating low levels of interaction, will not have much influence on the user's interest graph or social graph. But as scores for any items add up, they will reach a threshold score indicating that they should start having influence. These threshold levels cause interest topics to move from a state of no or low engagement to a state of high engagement—considered an implicit interest. An implicit interest based on interaction scores will in most instances not be considered as strong as an explicit interest topic that the user has explicitly added to their list of interests, but higher thresholds can still give it strong explicit strength in determining recommended interest topics for the given user.

As a user's scores add up for a particular interest topic, content item, user or other entity, the application can then determine which topics, content items or users are most important to the user. This information can be used to calculate implicit interests, favorite content types, or connection strength to other users. Eventually, scored interactions can also be expanded to calculate a user's influence and expertise on interest topics, people and brands.

Since the interaction data for each user is archived, it can be rescored if either the scoring algorithms or the scores for each interaction type are changed.

Other variables that can modify how interest topic scoring (and rescoring) takes place may include, but are not limited to the following:

The age of the interactions (older interactions will have reduced scores);

The duration between interactions with the same interest topics (interactions with the same interest topic over a period of a few minutes or a few hours—indicating momentary interests—may not affect scores as much as interactions with the same interest topics over a period of weeks or months—which indicate more durable interests);

The strength of the interest topic in the user's social graph (interest topics that are especially strong among a user's closest friends may have an increased scoring);

The strength of the interest topic to people who are similar to the user (interest topics that are especially strong among people who are considered similar to the user may have an increased scoring, using collective intelligence and collaborative filtering methodologies);

The category or type of interest topic (certain interest topic categories may be considered more evergreen—and thus more highly scored—while others may be considered less durable—with a reduced score).

The user graph 320 also can be updated through interest landing pages 306. Interest landing pages present a user with content in a category, and allow a user to indicate an interest in that content. In turn, the topics to which that content is related are scored in the user interest graph based on the user's input. The content on interest landing pages is created by accessing linked content pages 330 with a SICE engine 332, which processes the content on the linked pages. In particular, the SICE engine determines which topics the content relates to, which in turn allows in the interest landing pages to be generated. For example, the SICE engine can process a document to identify keywords, which in turn can be compared to terms in the ontology of interests used in the system. A document can be associated with each interest that matches the keywords identified in the document.

Having now described an overview of the system architecture, a few use cases will now be described.

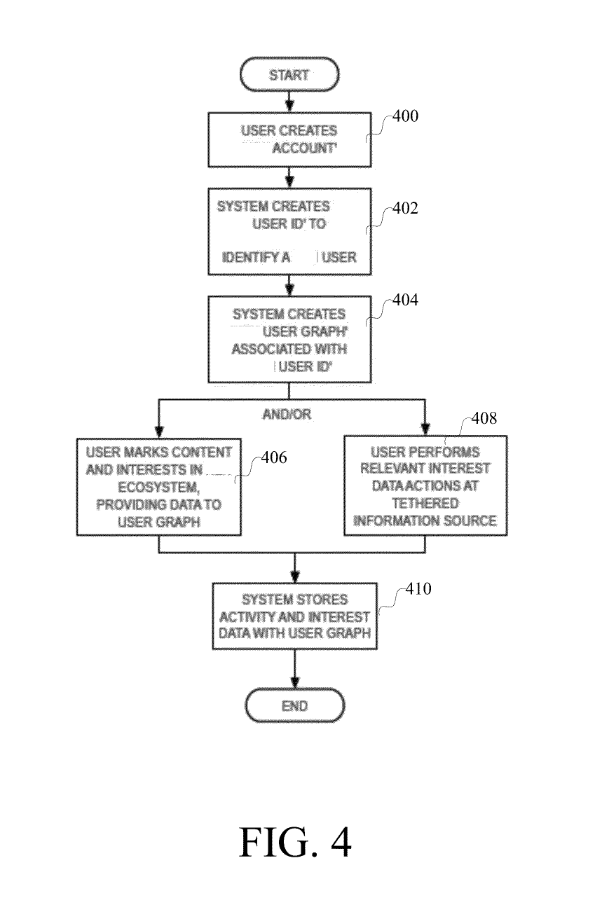

Referring now to FIG. 4, an example process for a user to create a user interest graph using the system of FIG. 3 will now be described. The process begins with a user creating 400 a user account with the user interest manager. This could be in the form of a conventional user account creation process for a web site on the internet. A user specifies a user name and password, and optionally other information, which is submitted to an access control system to create an account. Alternatively, authentication can be done through a third party. A user can use an account that is anonymous to the system, but is known to the user or a third party. The system then creates 402 a user identifier that identifies the user. The user identifier, in one implementation, is anonymous. As an example, such an identifier can be an alphanumeric string of many characters, and can be generated using any of a set of known functions for this purpose. The system then creates 404 a user graph associated with the user identifier. The user graph is empty in that there are no scores associated with any of the topics in the hierarchically ordered ontology of topics that define all user graphs.

The foregoing steps typically are performed once per user as part of an initialization process for a user. A variety of other steps can be performed to initialize a user, such as gathering and organizing profile data and the like.

After initializing a user, a user can take a variety of actions that will result in updates to the user interest graph. In general, a user can mark 406 content made available directly by the user interest manager system, such as through interest landing pages 306 in FIG. 3. Also, user interaction data from other tethered information sources can be received 408 and process, such as by the modules 316 and 318 in FIG. 3. The system the processes the user interaction information to update 410 the user interest graph. In particular, topics associated with the content viewed by the user are scored in that user's interest graph.

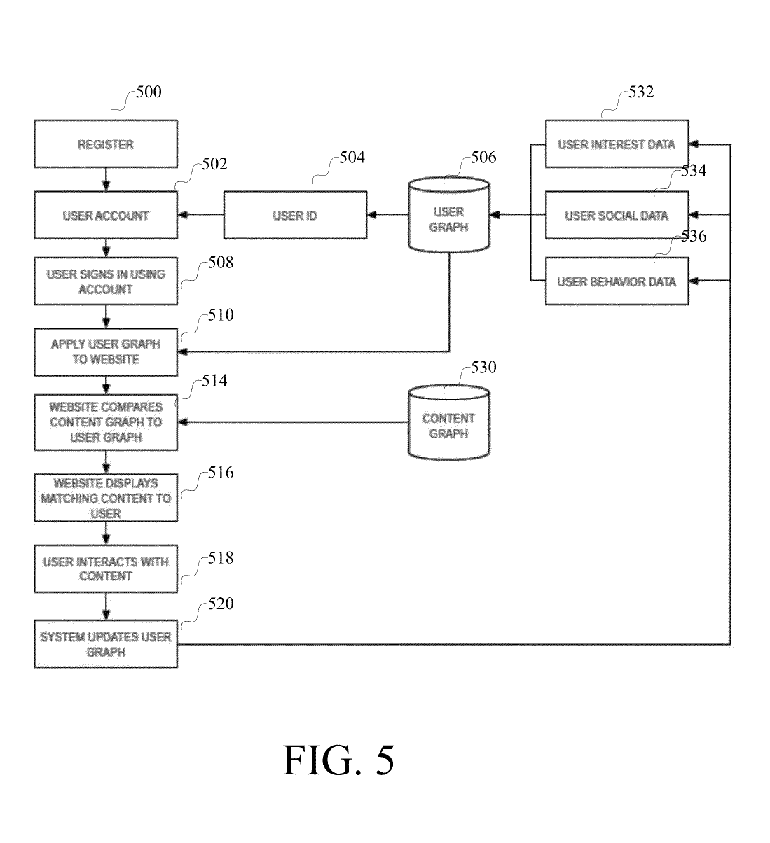

Referring now to FIG. 5, an example implementation of how a user interest graph can be used by an information source, such as a web site, will now be described in more detail. The user registers 500 with an information source and a user account is created 502. This user account is associated with the user's identifier at the user interest manager, as indicated at 504, which in turn is associated with the user's interest graph as indicated at 506, a combination of user interest data, user behavior data and user social data. When a user signs in 508 at the information source, the information source accesses 510 the user's interest graph. Given the user's interest graph, the information source can select content that matches the user's interests. For example, a graph also is created for the content, e.g., content graph 530, representing the topics to which the content relates. The content graphs for various content are compared 514 to the user's graph to identify matching content, which in turn is displayed 516 to the user. The user interacts 518 with the content, and the user interaction data is sent to the user interest manager. The user interest manager then updates 520 the user graph. As described in more detail below, the user graph 506 can include user interest data 532, user social data 534 and user behavior data 536, and the user interaction data can be used to update any of these parts of the user graph.

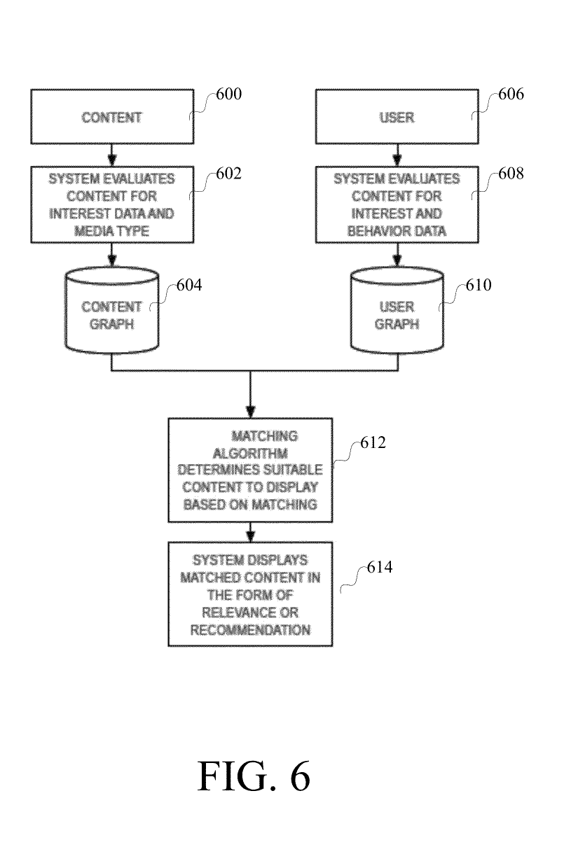

Referring to FIG. 6, an example implementation of how content is matched to a user's interest will now be described in more detail.

Content 600 is processed by the system 602 to determine media type and interest data, such as the topics to which it relates, to create a content graph 604. Such processing also can be performed by individuals in a manual process. Similarly, as described above, a user's activity 606 related to content is used by the system 608 to create the user's interest graph 610. Given the user interest graph and content graphs for multiple pieces of content, a matching algorithm 612 is applied to select suitable content. The system then displays 614 the selected content, and the display can include some indication of how the content is relevant to the user, such as in the form of a recommendation or an indication of a topic of interest. In one implementation, the matching 612 is performed by identifying topics that are found in both graphs that have non-zero scores. The number of matched topics can then be used to derive a score, such as a confidence score in the range of 0 to 1, that there is a match. The total number of topics in the graphs and the scores in the graphs can be used to compute this confidence value, for example,

In its simplest state, the matching algorithm merely finds content which has been determined to relate to at least one interest topic explicitly shared by the user. For example, if a user has indicated interest in a certain musical artist, an article or video related to that musical artist can be recommended to them. Newer content related to the user's interests in general is given a higher priority over older content.

In more advanced states, the matching algorithm takes into account other factors besides just a simple interest-to-interest match. Some specific examples include:

Multiple interests: Content that matches more than one of the user's explicit interest topics may be ranked more highly than content matching only one of their interest topics.

Implicit interests: Content that matches the user's highly-ranked implicit interest topics—topics that the user has interacted with many times, but has not explicitly added to their interest graph—may also be recommended, although usually at a lesser level than content matching explicit interests.

Similar interests: Content that matches interest topics that are similar to the user's interest topics (for example, another musical artist in the same genre as one of the user's interests) may be recommended.

Friend's interests: Content that matches interest topics that are shared by a significant number of the user's friends (social graph) may be recommended to the user.

Collective intelligence: Content that matches interest topics that are shared by a significant number of people who are similar to the user (determined via collective intelligence) may be recommended to the user.

Interest topic age: Content that matches interest topics that the user has recently added to their interest graph may be given a higher weighting than older interest topics.

Interest topic category: Content that matches interest topic categories that contain the majority of a user's interest topics may be given a higher weighting than content in other categories.

Content type: If a user's behavior graph indicates that they interact most frequently with certain content types (such as videos) and less frequently with other content types (such as photos), then the highest-engaged content type may be given a higher weighting than content of other types.

More advanced matching algorithms can take into account all of the above items to determine a match score that enables ranking of recommendations from very high to lower, based on the weight of each type of matching factors. A tunable threshold can determine what level of match score can be used to determine whether a particular piece of content is made visible to the user as a match.

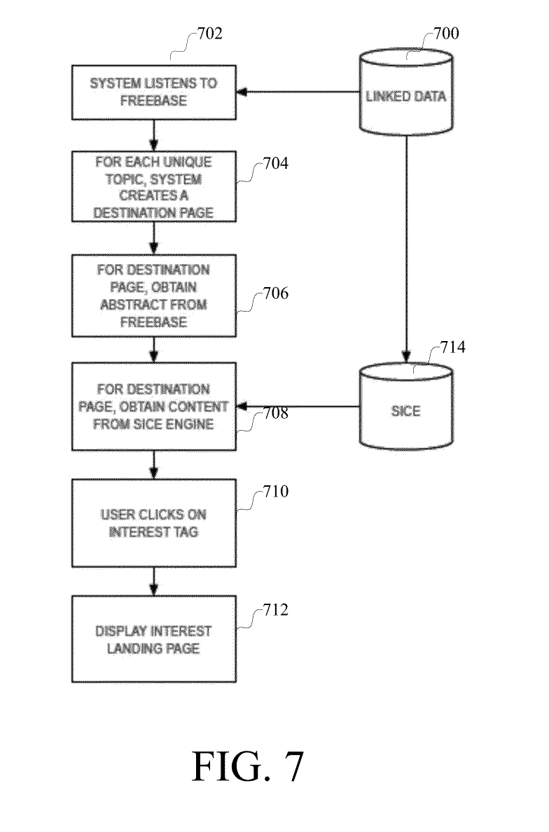

Referring now to FIG. 7, an example implementation of interest landing pages will now be described.

The generation of interest landing pages is based on collecting content from linked pages 700, and processing those pages to assign topics to the pages. Such processing can be done by extracting keywords, found in the interest ontology, from those documents. The system processes 702 a linked page to obtain an abstract, such as by using a web service called Freebase, for one example. Other sources may be used. An interest landing page is created 704 for each topic, and a linked page having that topic is associated with the interest landing page for that topic. For example, an abstract of the linked page can be obtained 706 and stored in association with the topic. The Semantic Inference Classification Engine (SICE) engine 714, described above, also can process the linked pages 700 to associate content with a topic. The content associated with the topic of the destination page is added to the page, as indicated at 708. A display is created that shows tabs or other indicators for various topics. A user selects 710 a topic, in response to which the system displays 712 a page for that topic that includes content from the linked pages 700 associated with that topic.

The SICE Engine is responsible for analyzing text or metadata for any content item or document to determine the interest topics that are most related to that item.

One component of the SICE engine is the UIMA framework, a framework maintained by the Apache Foundation, which makes it possible to build text annotators by combining annotators from different sources, thus allowing a scalable development process. A number of annotators may be inserted into the UIMA framework to accomplish various tasks related to classification. These are split into three groups: (i) prefiltering, (ii) concept extraction and (iii) post-filtering.

Pre-filtering annotators perform functions such as, but not limited to, language detection, link extraction, tag extraction (extracting metadata), part-of-speech detection and other linguistic analysis. Language detection is used to reject text in languages that cannot be evaluated. Links are extracted so that they can be followed, analyzed, and merged with the original document to enhance the interest topics that can be recognized.

Concept extractor annotators may include, but are not limited to, naïve extractors and tag extractors, for example.

A naive extractor looks for exact phrase matches in the document against surface forms (words and phrases representing topics) and may implement “stemming” by removing punctuation. This dictionary is aggressively pruned to contain only surface forms that are highly reliable, so there is no additional disambiguation. If there are multiple surface forms that overlap, the naive extractor will resolve both of them.

A tag extractor works like the naive extractor, but it has some adaptation to the fact that tags generally are truncated. For instance “Los Angeles” may get squashed to “losangeles” or “los_angeles”.

Post-filtering annotators complete the process. Some examples are the following.

A coherence meter can eliminate noise and estimate quality by looking for connections between concepts. “Poker face” could mean a lot of things, but it's plausibly a song if “Lady Gaga” is mentioned nearby. A simple version of a coherence meter can find all the links between concepts in a database (such as Freebase or DBpedia) and returns the “giant component” of concepts that are linked.

A wide classifier follows relationships upward in a categorical hierarchy, such as linking an artist name to a genre of music, to music generally as a topic.

Overlap removal removes any overlapping surface forms.

Relevance estimation for individual terms evaluates confidence of the classification and relevance (i.e., how important a concept is to a document).

An overall evaluator returns a level of confidence in the overall SICE result.

The post-filtering system may evaluate the results as a whole, consider correlations between concepts, decide to accept or reject results, format data for output into the platform, or decide which outbound queue data will go into.

To do their job, the annotators draw on knowledge bases, which can include surface forms. For example, the knowledge base can indicate links between surface forms and concepts, the reliability of surface forms, how to disambiguate terms, and key facts about entities.

At least three knowledge bases are used directly by annotators. Some examples are the following.

A surface forms knowledge base is a list of highly reliable surface forms (words and phrases representing interest topics) which are mapped to interests. Each surface form maps to one interest, and there is no disambiguation data. This may also include tags or numeric scores attached to surface forms to be used by the post-filtering system.

A coherence knowledge base is a pool of links between interests. These are associated by tags or numeric scores with the links, for use in post-filtering.

A hierarchy knowledge base understands categorical hierarchies of interest topics. For example, it knows that a specific musical artist is involved with the topic of “Music”.

Sources for information in these knowledge bases may include the following freely available data sources: Freebase, DBpedia, Common Crawl, n-grams and Wikipedia, among other sources of linked data and open data may also be used.

Intermediate databases used by the system to derive the primary knowledge bases may include, but are not limited to: a word frequencies database, which helps enable rejecting surface forms that are very common phrases and provides word frequency data; a bad words database, which includes a list of phrases that should be ignored; a normalized word forms database, which helps in the process of rejecting truncated names and expanding place names and enables replacing bad surface forms with good ones.

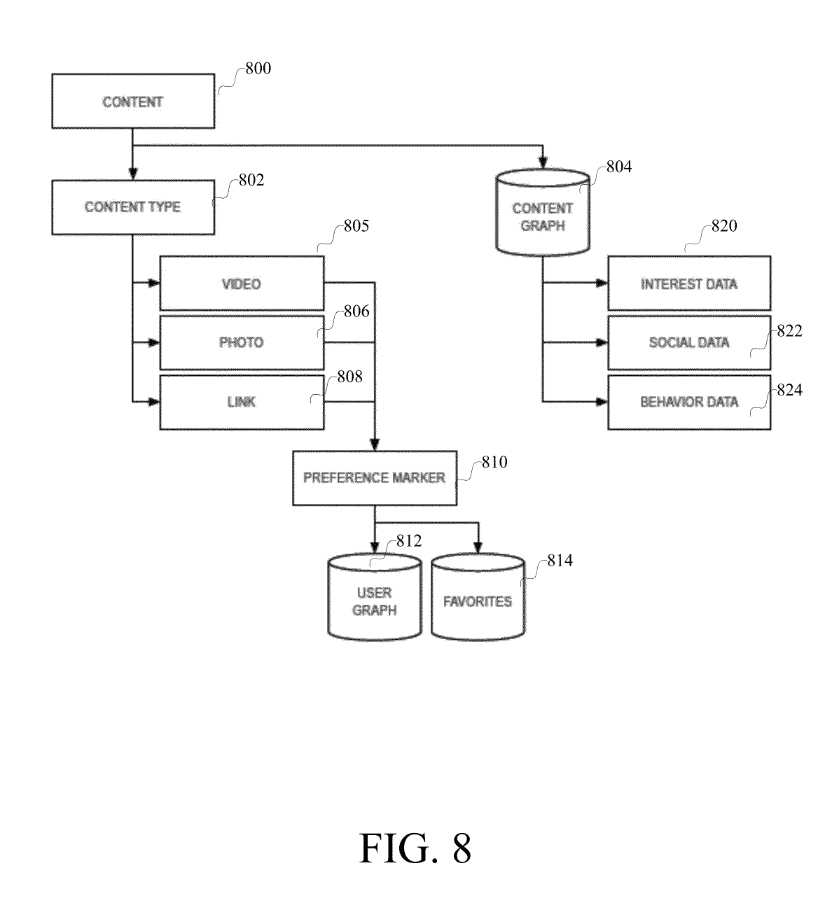

Referring now to FIG. 8, more details of an example implementation of how content can be processed will now be described. The content 800 is processed into a content type 802 and its content graph 804. The content type can include, for example, video 805, photo 806 and a link 808. Each of these can be associated with a preference marker 810, which is used to mark the user's graph 812 and optionally update favorites data 814. The content graph 804 includes interest data 820, social data 822 and behavior data 824, as described elsewhere.

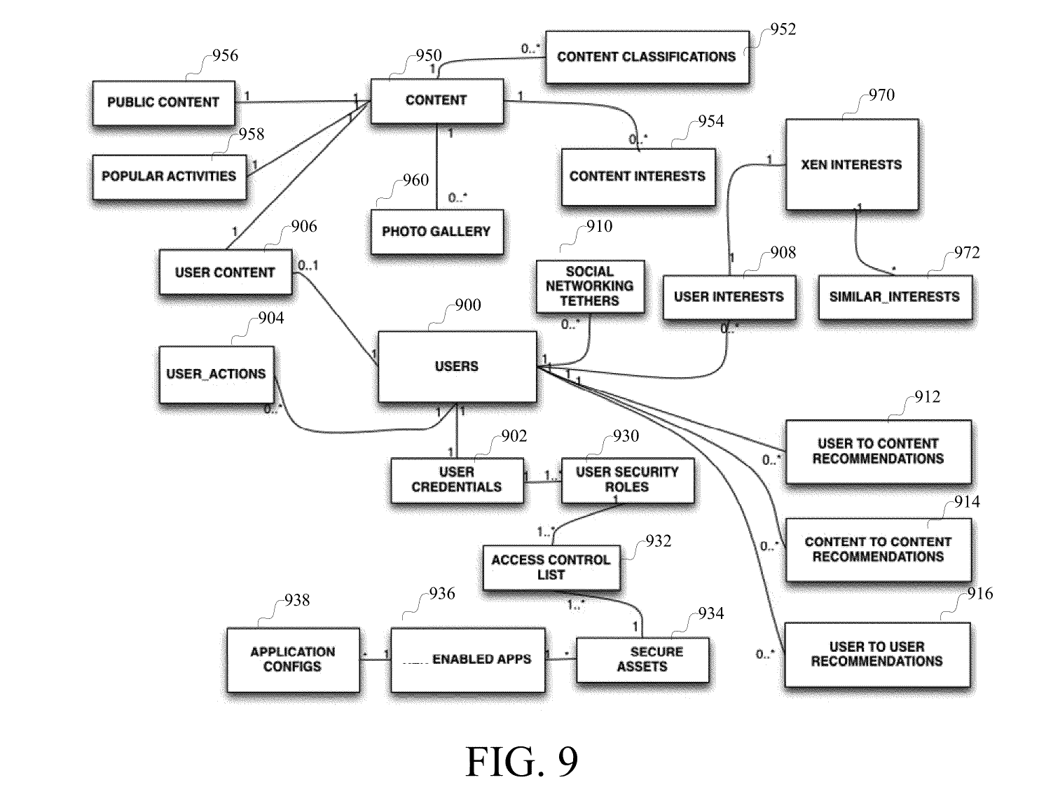

FIG. 9 is an illustration of an example data model for use in the user interest manager system.

At the center of the data model is a user 900. A user has an identifier and other credentials 902 on the system. These credentials include user security roles 930 which are part of the access control list 932. The access control list relates access controls to content 934 on the system, which are provided by applications 936 configured using configuration data 938 to use this system.

The user also has associated with it user action 904, user content 906, user interests 908, tethers (i.e., accounts with information sources for which activity will be tracked) 910. Each user also can have associated recommendations, such as user to content recommendations 912, content to content recommendations 914 and user to user recommendations 916. These can be generated by comparisons of content graphs and user graphs to other content graphs and user graphs. Content also is represented in the data model, as indicated at 950. Each item of content has one or more classification 952 and related interests 954. The interests associated with content allow content to be matched to user interests. Content may be designated as public content 956, associated with public activities 958, or added to a photo gallery 960 (for example). The system also can have its primary interest model 970, from which user interests 908 and similar interests 972 are derived.

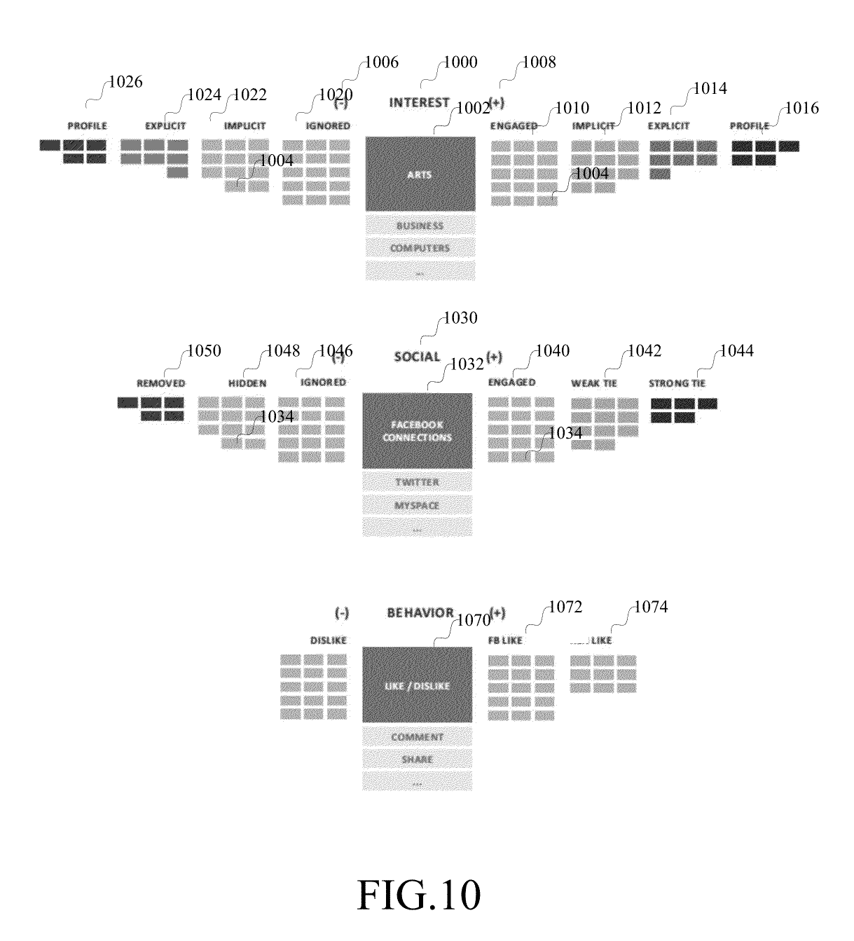

Referring now to FIG. 10, more details of an implementation of the user interest graph will now be provided.

As noted above, the user graph is divided into three areas: interests, social and behavior. Each graph measures the result of actions relevant to the specific graph. For example interest graph counts interests in various categories, and the social graph counts the number and nature of connections. Multiple variables can be compared across graphs or within graphs.

A sample interest graph is shown at 1000. A category 1002, such as arts, has several subcategories such as shown at 1004. Each subcategory can have a positive or negative interest, as shown at 1006 and 1008. Subcategories that have negative interest are shown on the left side of FIG. 10; those with positive interest are shown on the right side of FIG. 10. The subcategories can be scored with different measures of engagement strength (in addition to being positive or negative). As shown in FIG. 10, there are four levels of strength in this example. Other numbers of levels can be used. For positive, there is, from weakest to strongest, engaged 1010, implicit 1012, explicit 1014 and profile 1016. For negative, there is, from weakest to strongest, ignored 1020, implicit 1022, explicit 1024 and profile 1026. If a user explicitly states an interest or lack of interest on a topic, then that causes that topic to be marked as “explicit”. If a user expresses an interest (or lack of interest) in content that is associated with a topic, then that causes the topic to be marked as “implicit.” If a user had no action, then it is engaged or ignored. Some users might state an interest or lack thereof in their user profile, which would be the strongest level of interest. It should be understood that this is merely an example implementation and that other implementations are possible. There are a variety of ways to characterize levels of interest, and the manner in which the level of interest is determined

Similarly, the social graph shown at 1030 measures the number and strength of user's connections on different networks 1032. Each network is similar to a category in the interest graph, and user's on those networks are shown in a manner similar to subcategories, such as shown at 1034. There are three levels of positive, and three levels of negative, strength in this implementation of the social graph. The positive levels are engaged 1040, weak tie 1042 and strong tie 1044. The negative levels are ignored 1046, hidden 1048 and removed 1050. A strong or weak tie can be detected by the number of actions associated with the relationship. The negative levels are determined by users that have hidden or blocked communication from, or even removed, connections.

A behavior graph measures the number of times a user performs an action related to a topic or item of content or user. The types of actions are shown at 1070, similar to categories. Different levels can be created, and associated with different information sources, as shown at 1072 and 1074. “Dislike” and “Like” as shown could be further divided into multiple levels of degree of like and dislike.

This view of an interest graph in FIG. 10 can be used is graphical user interfaces to visualize an interest graph.

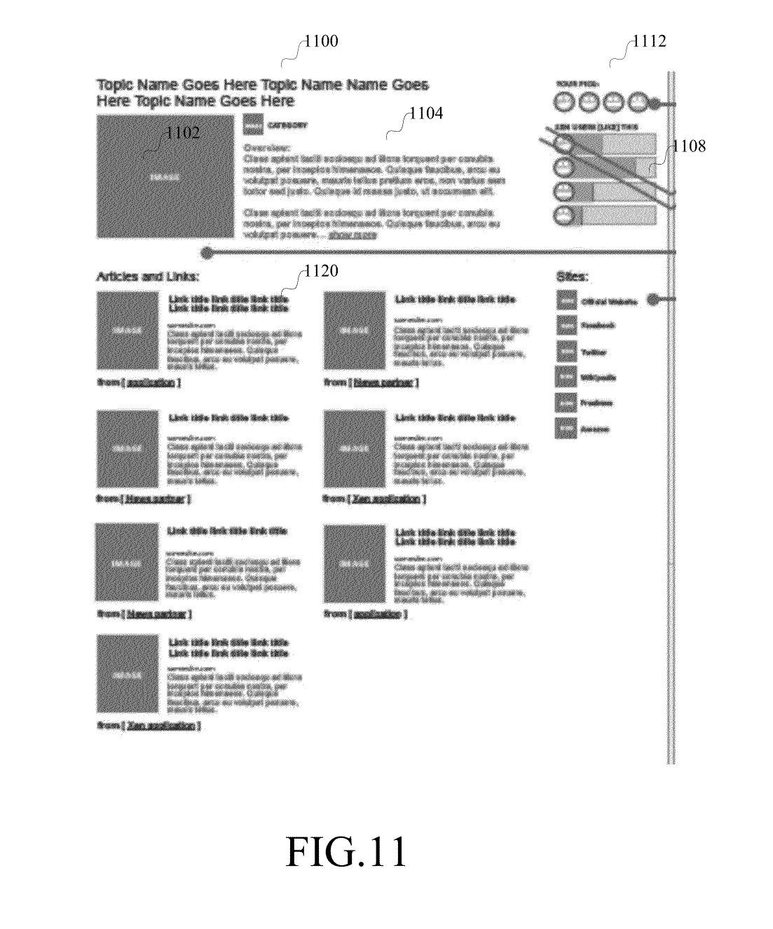

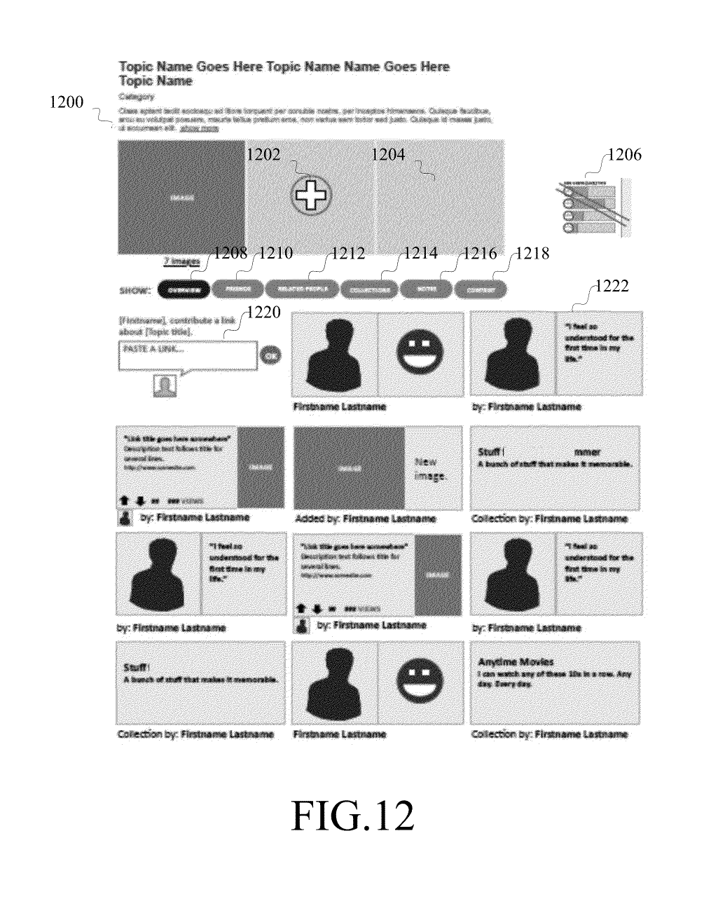

Referring now to FIG. 11, an example graphical user interface through which explicit interest information can be obtained will now be described. Such a graphical user interface can be displayed, for example, as part of 712 of FIG. 7.

The graphical user interface for an interest profile page includes a topic 1100 that describes the topic in which the content on the page belongs. There can be associated images 1102 for the topic and additional text 1104.

The number of people who are interested in this topic can be displayed at 1108. In this example, the number of people for each level of interest in this topic is expressed as a color-coded bar graph. A user can indicate interest in the topic, generally, by selecting the interest tag 1112. In this example, the interest tag is represented by four emoticons from which a user can select. Articles and links related to the topic, and sites that source those links, can be displayed at 1120 below the topic, interest tag and bar graph of other users' affinity for the topic.

By interacting through the user interface of FIG. 11, a user's interest in content items, and their topics, can be tracked in user interest graphs. For example, one of the content items 1120 can be selected an viewed. However, if its interest tag is not selected, then the interest in that item is only implicit, not explicit. Another view of interests is shown in FIG. 12 which shows the use of interests in a social media context. An interest page can have a title, text and associated image, for example, as indicated at 1200. At 1202, a user can enter an indication of interest, along with any commentary or other information in the area indicated at 1204. The color coded bar graph of all users' expressions of interest can also be shown in the area 1206. On the bottom half of this view, various content can be displayed. In this example, there are six types of the bottom half view, but the invention is not limited to these particular types, or any number of types. Each different view can be selected by a user manipulating one of the labeled selectors 1208, 1210, 1212, 1214, 1216 and 1218.

An overview can be selected as indicated at 1208. In this view, a user is prompted at 1220 to input something about the topic, such as a link or commentary or the like. After a user inputs data, the inputs can be displayed in reverse chronological order, such as indicated at 1222. Each input can be displayed as a pair of content, such as an image and text.

A friend view can be selected as indicated at 1210. In this view a user can see everything related to people whom that user is following. For example, this page can show people's expressions of interest or other data input, notes on this and other topics and the like. The inputs can be displayed in reverse chronological order.

A related people view can be selected as indicated at 1212. This view is similar to the friends view, but shows friends and other people who have expressed interest in this topic. Inputs from friends can be displayed first, followed by other people, with each group being shown in reverse chronological order.

A collections view can be selected as indicated at 1214. In this view, any collection that includes this topic is shown. Information from these collections is shown in reverse chronological order. A notes view can be selected as indicated at 1216. In this view, any notes made by users for this topic are shown. These notes are shown in reverse chronological order. A content view can be selected as indicated at 1218. In this view, any links associated by users with this topic are shown. These links are shown in reverse chronological order based on when they are input by users.

Having now described an example implementation, a few words about its implementation on a general purpose computer will now be provided. A general purpose computer on which such a system can be built, typically includes one or more central processing units and memory. Memory may be volatile, non-volatile or some combination of the two. Such a computer also may have storage, that can be removable and/or non-removable. Computer storage media includes volatile and nonvolatile memory, removable and non-removable storage to store information such as computer program instructions, data files or other data. Memory and storage are examples of computer storage media. Computer storage media includes any device that stores information and which can be accessed by computing device to retrieve the stored information.

A computer also can include communications interfaces that allow the computer to communicate with other devices over a communication medium, such as over a computer network. A communication medium is any medium for transmission of data on a modulated carrier signal, and can be wired or wireless. The communication interface transmits data to and receives data from the communication medium.

The computer may have various input devices, such as a keyboard, mouse, camera, touch input device, and so on, and output devices such as a display, speakers, a printer, and so on. Applications executed on the computer are implemented using computer-executable instructions and/or computer-interpreted instructions, such as program modules, that are processed by the computing device. Generally, program modules include routines, programs, objects, components, data structures, and so on, that, when processed by a processing unit, instruct the processing unit to perform particular tasks or implement particular abstract data types.

It should be understood that the subject matter defined in the appended claims is not necessarily limited to the specific implementations described above. The specific implementations described above are disclosed as examples only. Combinations and variations of such implementations also can be made.

What is claimed is:

1. A computer-implemented process for centrally tracking interest data from distributed information sources, comprising:
defining, for each user, a user interest graph, wherein a user interest graph comprises a hierarchically ordered ontology of topics, and a user's interest in a topic is represented as a score associated with the topic;
receiving, from a first information source, first data describing a first user's interaction with the first information source into memory;
receiving, from a second information source different from the first information source, second data describing the first user's interaction with the second information source into memory;
receiving, from a third information source, third data describing a second user's interaction with the third information source into memory;
receiving, from a fourth information source different from the third information source, fourth data describing the second user's interaction with the fourth information source into memory;
generating a first interest graph of the first user's interests from the first data and the second data;
generating a second interest graph of the second user's interests from the third data and the fourth data;
storing and maintaining the first and second interest graphs.

2. The computer implemented process of claim 1, wherein data describing a user's interaction with an information source comprises an indication of content accessed by the user, one or more topics associated with the content, and an action by the user associated with the content.

3. The computer implemented process of claim 1, further comprising:
presenting content to a user;
presenting an interest tag associated with the content to the user;
tracking user input related to the interest tag.

4. The computer-implemented process of claim 3, wherein the interest tag represents an interest, and is associated with content and is displayed on a user's display adjacent that content.

5. A computer system for maintaining information about user interests from a plurality of users, for each user, a user interest graph, wherein a user interest graph comprises a hierarchically ordered ontology of topics, and a user's interest in a topic is represented as a score associated with the topic.

6. A computer implemented process for gathering user interest information, further comprising:
presenting content to a user;
presenting an interest tag associated with the content to the user, wherein the interest tag is associated with a topic;
tracking user input related to the interest tag;
updating an interest graph comprising a plurality of topics according to the tracked user input.

7. A computer system for centralizing tracking and aggregating of user interests from a plurality of information sources, comprising:
an account manager that receives information from a user about account information for the user for accounts on each of the plurality of information sources;
receiving information from the plurality of information sources, including an indicator of the user; and
using the account information from the account manager, identifying a user associated with the received information and storing the received information along with other received information for the user to aggregate information about the user's interests.

8. A computer-implemented process for recommending content based on centrally tracked interest data from distributed information sources, comprising:
defining, for each user, a user interest graph, wherein a user interest graph comprises a hierarchically ordered ontology of topics, and a user's interest in a topic is represented as a score associated with the topic;
comparing the interest graph of a user to another interest graph to obtain a comparison result;
recommending content to the user based on the comparison result.

9. The computer implemented process of claim 8, wherein the other interest graph is related to an entity.

10. The computer implemented process of claim 8, wherein the other interest graph is related to content.

11. The computer implemented process of claim 8, wherein the other interest graph is related to a user.

12. The computer implemented process of claim 8 wherein the content is an advertisement.

13. The computer implemented process of claim 8 wherein the content is a link to another user.
